(19) United States
(12) Patent Application Publication
(10) Pub. No.: US 2006/0127665 A1
(43) Pub. Date: Jun. 15, 2006

(54) Method of controlling light diffusion and/or reducing glare from a surface

(76) Inventors: Akira Masutani, Fellbach (DE); Bettina Schüller, Stuttgart (DE); Michael Dürr, Esslingen (DE); Anthony Roberts, Stuttgart (DE); Akio Yasuda, Esslingen (DE)

Correspondence Address: FROMMER LAWRENCE & HAUG LLP, 745 FIFTH AVENUE, NEW YORK, NY, 10151, US

(21) Appl. No.: 11/266,873

(22) Filed: Nov. 4, 2005

Related U.S. Application Data
(63) Continuation of application No. 11/165,851, filed on Jun. 24, 2005.

(30) Foreign Application Priority Data
Jun. 25, 2004 (EP) 04014949.4

(51) Int. Cl. B05D 5/12; B05D 1/12; B05D 3/12; B05D 3/02; B05D 1/02; B05D 1/18; B32B 5/16

(52) U.S. Cl. 428/323; 427/180; 427/372.2; 427/355; 427/430.1; 427/421.1; 427/240; 427/58

(57) ABSTRACT

The present invention relates to a method of controlling light diffusion and/or glare from a surface, in particular from a reflective back plane. It furthermore relates to a display with controlled light diffusion and to the use of a nanoparticle film for controlling light diffusion and/or glare from a surface.

This is a Continuation-in-Part of application Ser. No. 11/165,851, filed Jun. 24, 2005, the entirety of which is incorporated herein by reference.

The present invention relates to a method of controlling light diffusion and/or glare from a surface, in particular from a reflective back plane. It furthermore relates to a display with controlled light diffusion and to the use of a nanoparticle film for controlling light diffusion and/or glare from a surface.

Reflective displays usually have a light diffusing back plane or a gain reflector in order to maximize the use of surrounding light. They rely on ambient light for information display and hence are ideal to devices for portable electronic equipment, since the need for backlight illumination is obviated. Nevertheless, reflective displays suffer from inherent difficulties in producing high contrast and high colour images with adequate resolution. There are a number of reflective display technologies, incorporating different modes, for example transmission mode (such as TN display), absorption mode (such as guest host display), selective reflection mode (such as cholesteric LCD mode), and scattering mode (such as polymer dispersed liquid crystals). In all of these, the light diffusion properties of the reflective back plane are limited, which means that the viewing angle of the display is narrow. Furthermore, there is a metal-like glare from the back plane of the display due to the interference of the reflected light. One way of approaching this problem has been to include surface irregularities on the reflective back plane, also referred to as protuberances or microreflective structures. By modifying the height, size and/or location of these protuberances researchers have tried to maximize light diffusion from the reflecting back plane. Various methods exist in order to create such protuberances. For example protuberances can be made by using a stamping method. However, if, for some reason, the diffusion properties are to be changed, the stamp must be redesigned, or a completely new stamp must be used. Another method for producing protuberances is photolithography. Again, if the diffusion properties are to be changed, the lithography mask and/or lamp must be redesigned. Consequently, the optimization/redesign of protuberances require considerable resources in terms of time, finances and logistics.

Accordingly, it was an object of the present invention to provide for alternative ways for maximizing the light diffusion from a back plane in a display and/or to reduce the glare from such a plane. Furthermore it was an object of the present invention to provide for a method to maximize light diffusion from such a plane, which is easy to perform and which does not require extensive financial or logistical effort.

All these objects are solved by a method of controlling light diffusion and/or reducing glare from a surface, in particular a back plane in a display, comprising the steps:

a) providing a surface,

b) preparing a dispersion of particles having an average diameter in the range of from about 1 nm to about 10 μm, preferably a dispersion of nanoparticles,

c) applying said dispersion onto said surface,

thus creating a particle film, preferably a nanoparticle film on said surface.

In one embodiment said method comprises the additional step:

d) drying said dispersion on said surface and/or curing said dispersion, preferably by heat or

The film created by said drying and/or said curing step is herein also referred to as “particle film” or “nanoparticle film”. Hence a “particle film” or “nanoparticle fim” may be a film prepared by the method comprising steps a)-c) or by the method comprising steps a)-d).

Preferably, said particles are nanoparticles having an average diameter in the range of from 1 nm to 10 μm preferably 5 nm to 900 nm, more preferably 10 nm to 500 nm, most preferably 10 nm to 300 nm.

In one embodiment, said dispersion of particles, preferably of nanoparticles contains one, two or more types of particles, each type being characterized by an average diameter, with different types of particles having different average diameters, wherein preferably said dispersion contains a first type of nanoparticles having an average diameter of 10 nm and a second type of nanoparticles having an average diameter of 300 nm.

In one embodiment, said particle film, preferably said nanoparticle film has a thickness of 0.2 μm to 5 μm, preferably 0.3 μm to 4 μm, more preferably 0.5 μm to 3 μm, even more preferably 0.5 μm to 2 μm, most preferably 0.5 μm to 1 μm. In one particular embodiment, said particle film, preferably said nanoparticle film has a thickness below 1 μm, preferably in the range of from about 300 nm to about 1 μm, wherein preferably for this embodiment, nanoparticles having an average diameter of about 100 nm are used.

In one embodiment, said dispersion of particles, preferably said dispersion of nanoparticles has a concentration of particles, preferably nanoparticles of 1-50 wt. %, preferably 1-40 wt. %.

Preferably, said particles, preferably said nanoparticles are made of a material selected from the group comprising TiO₂, SiO₂, CeO₂, Al₂O₃, MnO₂, Fe₂O₃.

In one embodiment, said dispersion of particles, preferably nanoparticles contain at least one solvent which does not dissolve said particles, and/or a UV or heat curable polymer.

The idea of using a solvent is that such solvent may, after application of the dispersion, be removed by drying, leaving a film of particles/nanoparticles behind.

Preferably, said solvent is selected from the group comprising water, ethanol, 1-propanol, isopropanol, butanol, toluene, dichloromethane, THF, 2-propanol, methanol, acetone, DMF and DMSO and mixtures thereof.

The idea of using a heat/UV curable polymer is that the dispersion containing the particles and the non-cured polymer is applied onto said surface, and thereafter a curing step is performed thus creating a particle film having a cured polymer matrix and the particles embedded in said matrix.

In one embodiment, said applying occurs by a process selected from doctor blading, drop casting, spin casting, Langmuir-Blodgett-techniques, sol-gel, spin coating, dip-coating, spray coating.

In one embodiment, said nanoparticles are applied in a dispersion together with a resin, preferably an epoxy resin, that may be curable by heat or light. As a result the nanoparticle film contains nanoparticles embedded and/or dispersed in said epoxy resin.

In a preferred embodiment, said resin, preferably said epoxy resin, forms a layer having a thickness in the range of from 0.1 μm to 2 μm, preferably 0.5 μm to 1.5 μm, more preferably 0.5 μm to 1.2 μm.

In one embodiment, said surface is a reflective surface, in particular a reflective back plane in a display, or it is a transparent surface, in particular a transparent back plane in a display.

Preferably, said surface further has an additional layer on top of it facilitating said particle film, preferably said nanoparticle film, adhering to said surface, or protecting said surface from reacting with said particle film, preferably said nanoparticle film.

In a preferred embodiment, said additional layer is made of a material selected from the group comprising polyimide, SiO₂, LiF, MgO, Al₂O₃, Si₃N₄.

Preferably, said drying and/or said curing occurs in vacuum or in air under ambient conditions. If heat curing is performed, the conditions will depend on the particular heat curable polymer selected.

Preferably said surface is made of a material, selected from the group comprising glass, polymers, silicon, steel, and a composite material, wherein, more preferably said surface is coated with a transparent material, for example indium tin oxide (ITO), fluorine-doped tin oxide (FTO), SnO₂, ZnO, Zn₂SnO₄, ZnSnO₃, CdSnO₄, TiN, Ag, or with a reflective material, for example a metal, such as silver, gold, platinum.

In one embodiment, steps c) and d) are repeated, preferably several times, thus creating a particle film, preferably a nanoparticle film comprising at least two, preferably several layers of particles, preferably nanoparticles.

In one embodiment said steps a) and b) are performed in the order ab or ba.

The objects of the invention are also solved by a display comprising a back plane having a particle film, preferably a nanoparticle film on top of it, preferably produced by the method according to the present invention.

The objects of the present invention are also solved by a particle film on a surface produced by the method according to the present invention.

The objects of the invention are furthermore solved by the use of a particle film, preferably of a nanoparticle film, as defined above, when applied to a surface, as defined above, in particular a reflective back plane in a display, for controlling light diffusion and glare from said surface.

The inventors have surprisingly found that by applying a simple nanoparticle film on a reflecting back plane, the light diffusion properties can be maximized and the glare from such surface can be reduced. For example, reflectivities of 60% and contrast ratios of approximately 6 can be achieved with only a moderate viewing angle dependency.

In the following the invention will be further described by reference to the following examples which are given to illustrate, not to limit the invention. Furthermore, reference is made to the figures, wherein

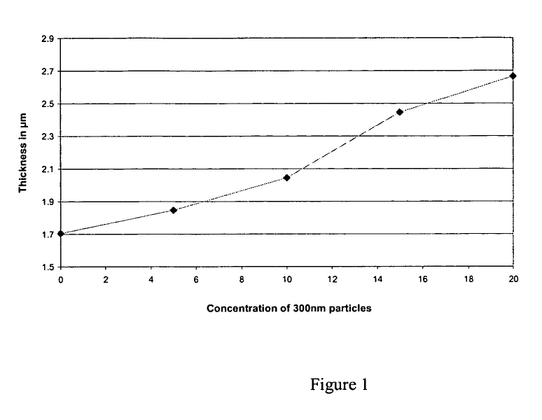

FIG. 1 shows the dependency of the resultant nanoparticle film thickness in μm on the concentration in wt. % of nanoparticles of an average diameter of 300 nm, from example 1;

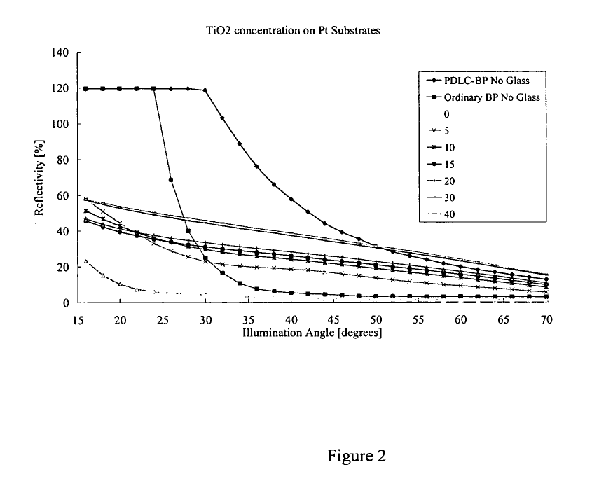

FIG. 2 shows the reflectivity of TiO₂ coated platinum substrates versus illumination angle, in dependence on the concentration in wt. % of the nanoparticles;

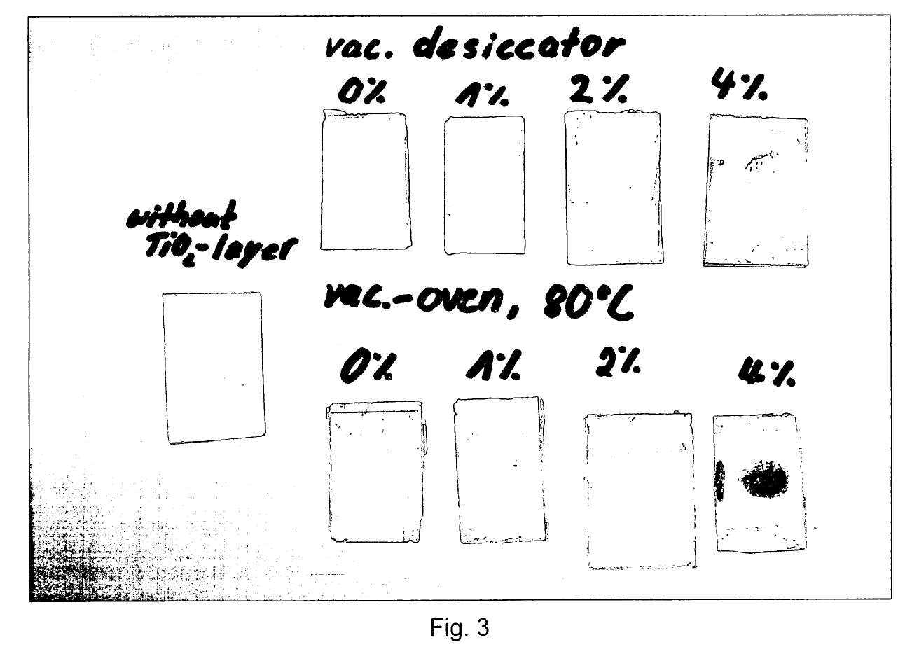

FIG. 3 shows manufactured examples of various wt. % concentrations of nanoparticles applied on a TFT back plane; the upper row shows surfaces dried in a vacuum desiccator, the lower row shows samples dried in a vacuum oven at 80° C.; also shown is a substrate without a nanoparticle film (left);

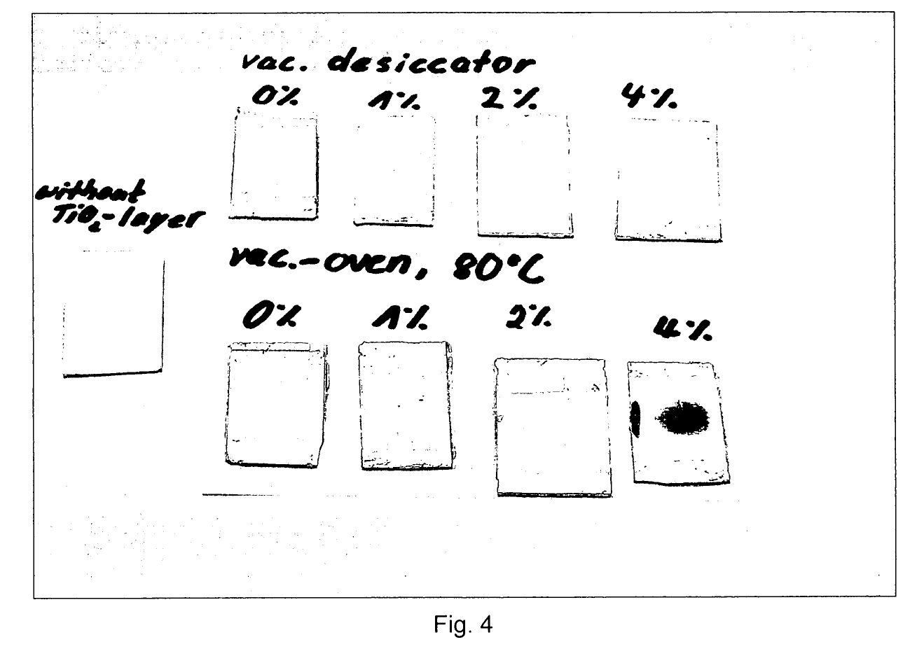

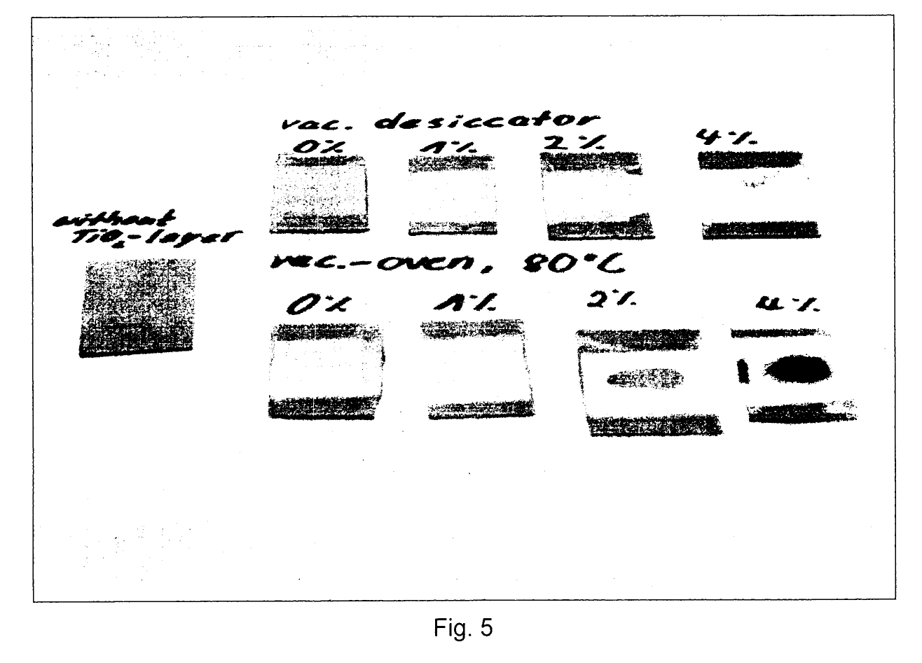

FIGS. 4 and 5 show the same surfaces of FIG. 3 at an angle of 30 degrees to the surface normal (FIG. 4) and 60 degrees to the surface normal (FIG. 5);

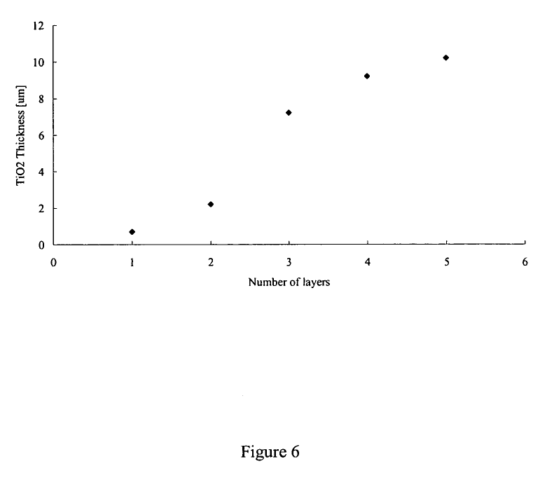

FIG. 6 shows the dependency of the nanoparticle film thickness on the number of nanoparticle layers applied in such a film on the surface.

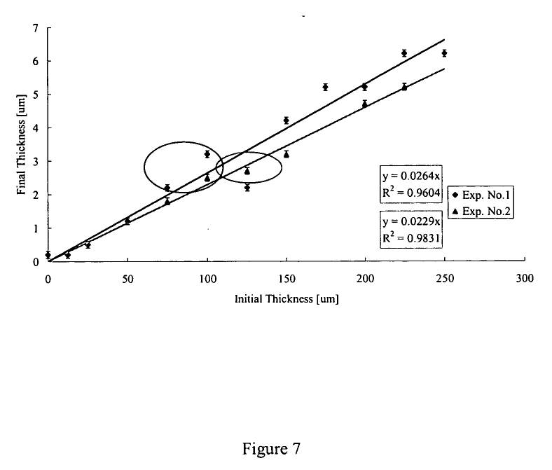

FIG. 7 shows the dependency of the final thickness of a nanoparticle film on the initial thickness and the drying condition;

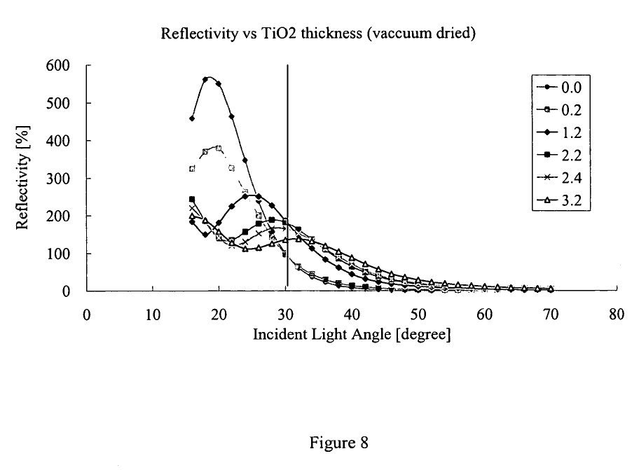

FIG. 8 shows the dependency of the reflectivity on the thickness of the nanoparticle films. (numbers in the box indicate the thickness in μm), depending on the incident light angle; the nanoparticle films were dried in vacuum;

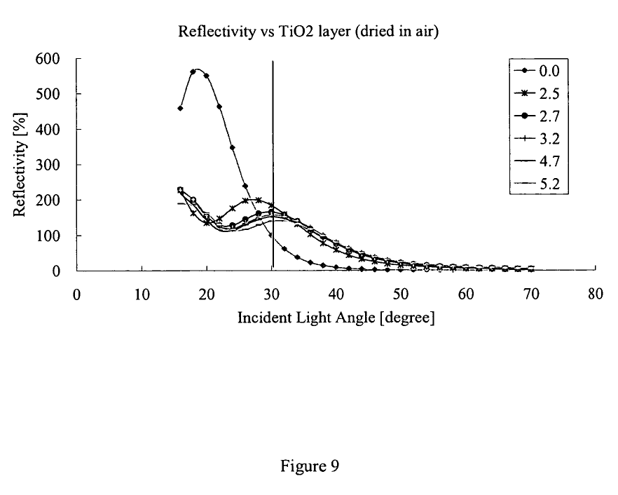

FIG. 9 shows the reflectivity depending on the thickness of the nanoparticle films, this time dried in air; again, the numbers in the box indicate the thickness in μm;

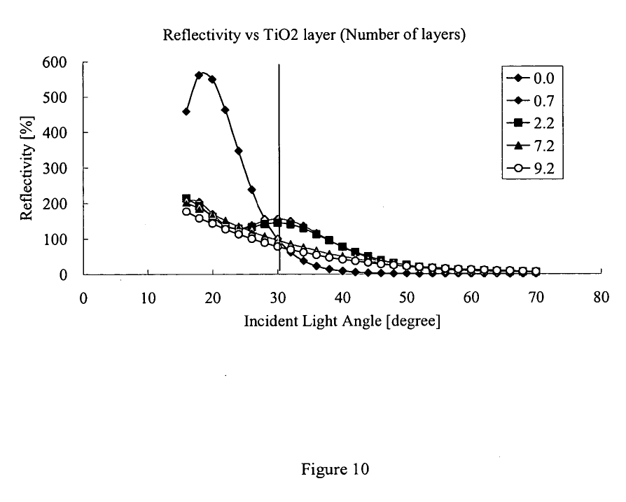

FIG. 10 shows the reflectivity depending on the nanoparticle layer thickness (again the numbers in the box indicate the thickness of the nanoparticle film in μm);

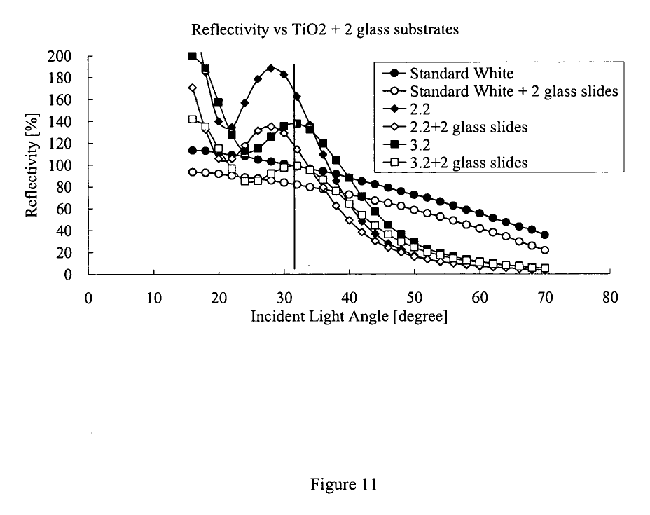

FIG. 11 shows the reflectivity of a back plane on which a 3.2 μm/2.2 μm nanoparticle film had been applied, with and without two glass slides on top;

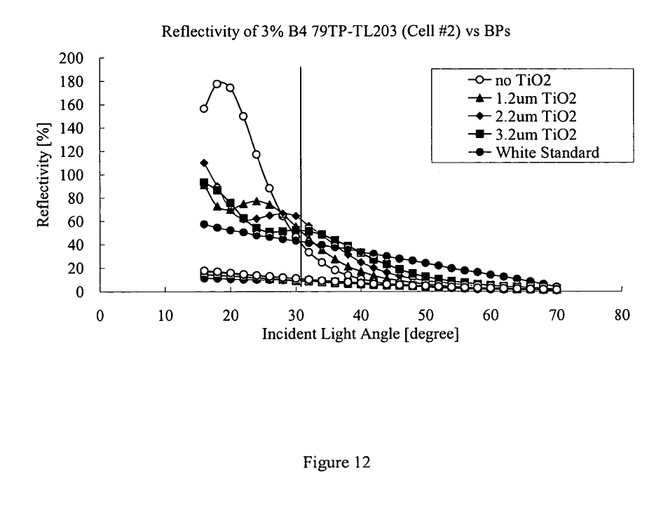

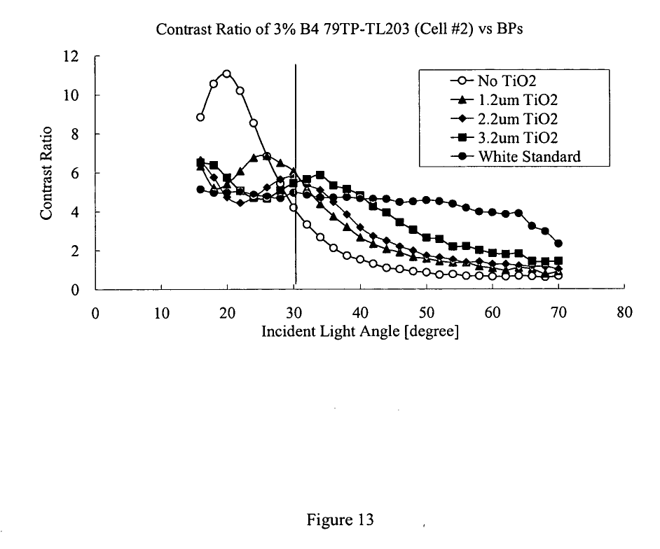

FIGS. 12 and 13 show the reflectivity (FIG. 12) and contrast ratio (FIG. 13) depending on the thickness of the nanoparticle film; a white standard is a spectral diffuse reflectance standard; it is the industry standard for instrumental and visual reference for the paper, textile, and plastic industries; typically it has reflectance values of 95% to 99% and is spectrally flat over the UV-VIS-NIR spectrum (ultraviolet-visible-near infrared),

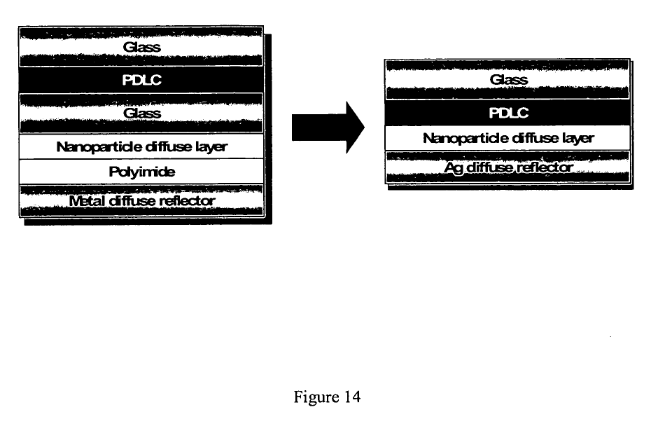

FIG. 14 shows a cell as used in Example 5 using two glass substrates, on the left, and a cell using only one substrate and the nanoparticle diffuse layer in direct contact with the metal diffuse reflector (on the right), as used in parts of Example 6, in some embodiments of Example 6 for reflectivity measurements the PDLC-layer has been left out,

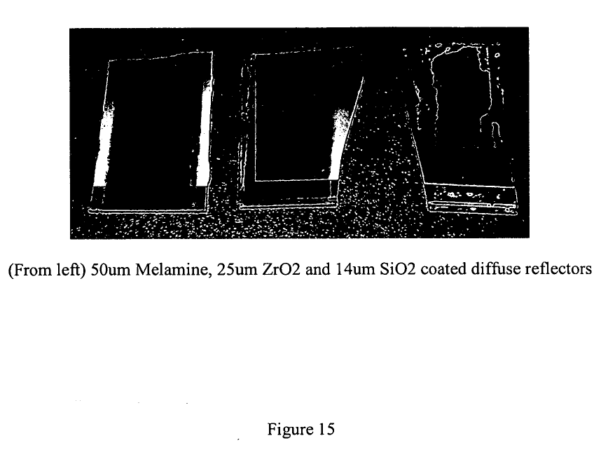

FIG. 15 shows various diffuse reflectors coated with different nanoparticulate films with 50 μm thickness for melamine nanoparticles, 25 μm thickness for ZrO₂-nanoparticles and 14 μm thickness for SiO₂-nanoparticles.

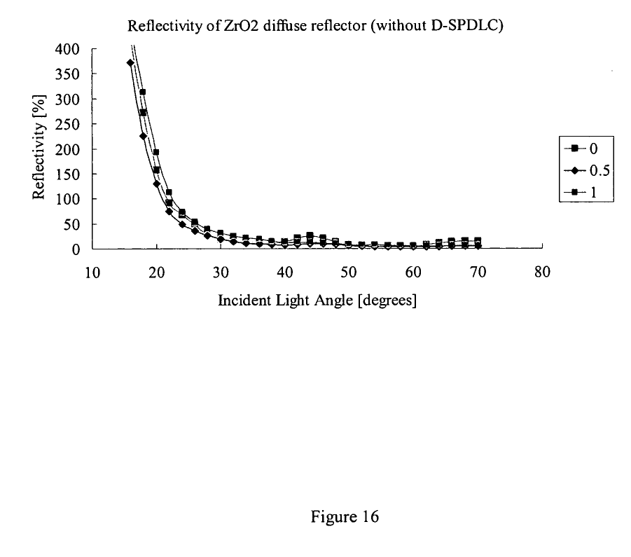

FIG. 16 shows the reflectivity of a ZrO₂-nanoparticle coated diffuse reflector in dependence on the incident light angle and various dilutions of the nanoparticles (0, 0.5 and 1 denoting “no diffuse layer”, “diffuse layer with half of ZrO₂ concentration of paste 1”, and “diffuse layer with paste 1”)

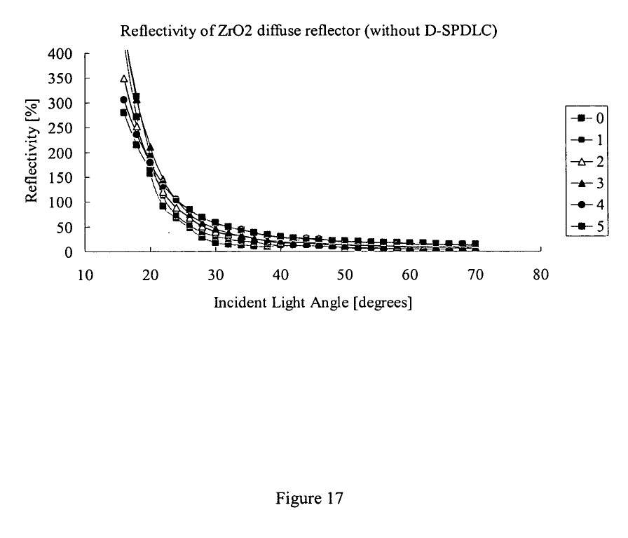

FIG. 17 shows the reflectivity of a ZrO₂-nanoparticle coated diffuse reflector (without D-SPDLC) on the incident light angle and the number of spin coating steps employed for applying the ZrO₂ layer, (0, 1, 2, 3 . . . denoting the number of spin coating steps)

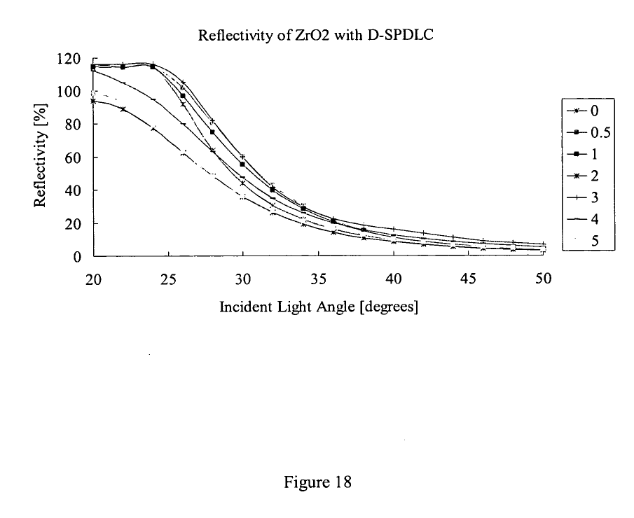

FIG. 18 shows the reflectivity of a ZrO₂-nanoparticle coated diffuse reflector in a cell with D-SPDLC on the incident light angle and the number of spin coating steps employed in application of the ZrO₂ layer, (0, 0.5, 1, 2, 3 etc. denoting the number of spin coated layers of paste 1),

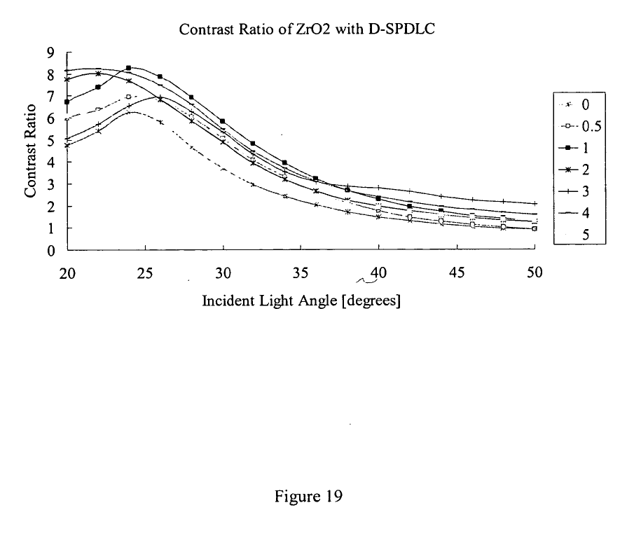

FIG. 19 shows the contrast ratio of the same cell as FIG. 18 on the incident light angle,

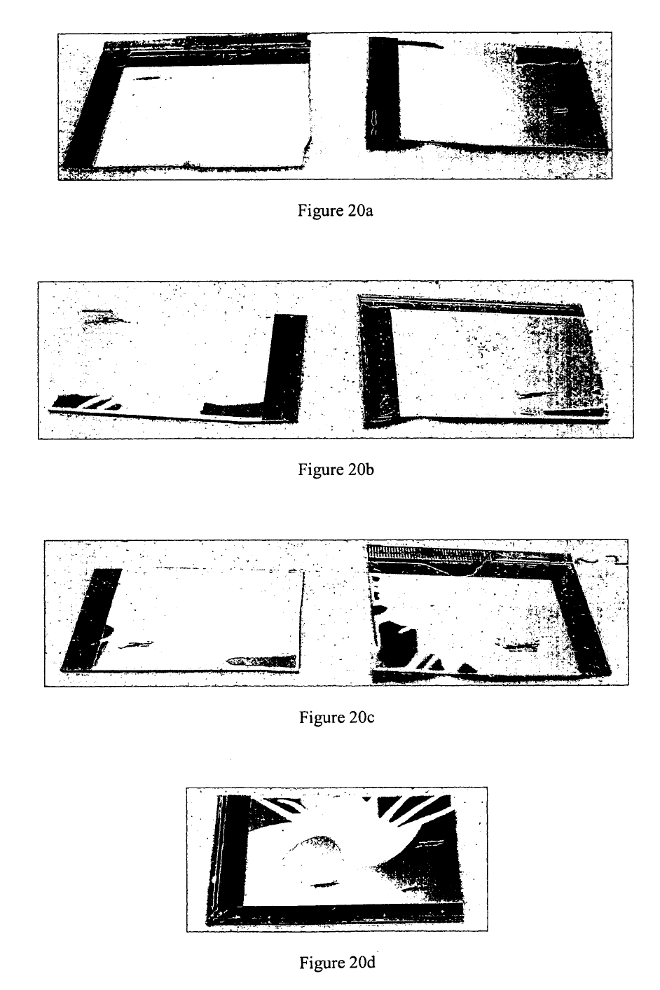

FIG. 20a-20d shows nanoparticulate films dispersed in epoxy resin on a reflector. In FIG. 20a, melamine (S6) yielded an approximately 1 μm thick layer for 10 wt. % loading (left), and an approximately 1.5-3.5 μm thick layer for 20% wt. % loading (right). In FIG. 20b, SiO₂ yielded an approximately 0.5 μm thick layer for 10 wt. % loading (left), and a 0.5-1.5 μm thick layer for 20 wt. % loading (right). In FIG. 20c, ZrO₂ yielded an approximately 0.5-1.5 μm thick layer for 10 wt. % loading (left), and an approximately 2 μm thick layer for 20 wt. % loading (right). In FIG. 20d, pure epoxy (NX 7020), with no particles, produced an approximately 2.5 μm thick layer.

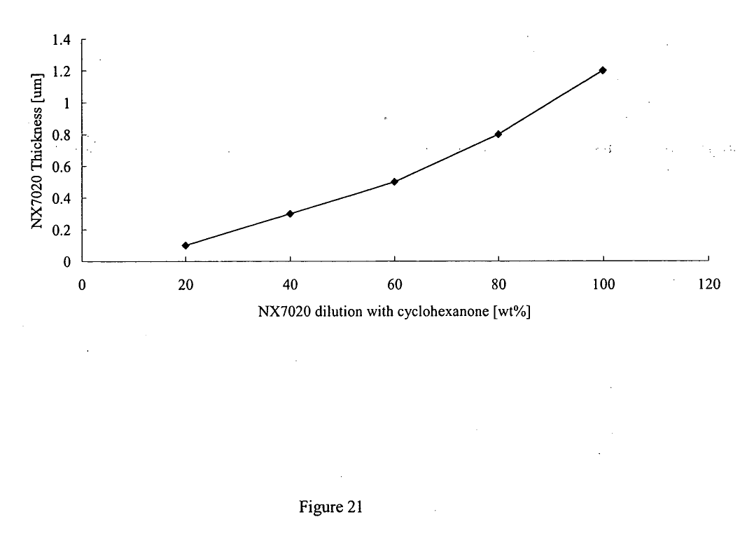

FIG. 21 shows the thickness of the epoxy resin layer in dependence on its dilution with cyclohexanone,

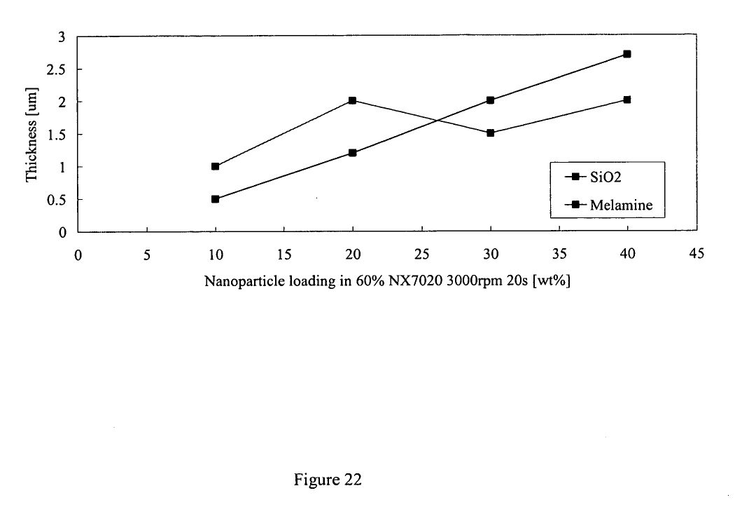

FIG. 22 shows the thickness of the epoxy resin for SiO₂-nanoparticles and melamine-nanoparticles in dependence on the concentration of nanoparticles,

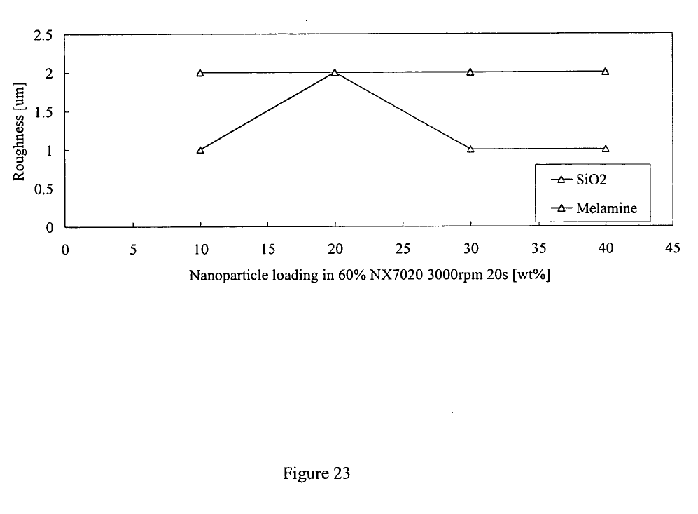

FIG. 23 shows the roughness of the epoxy layer for SiO₂-nanoparticles and melamine-nanoparticles in dependence on the concentration of nanoparticles,

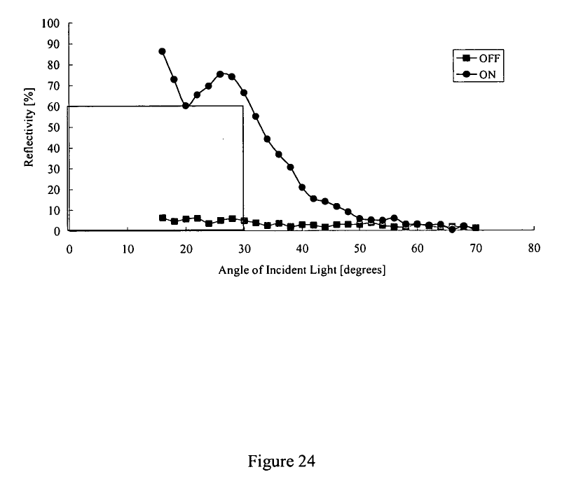

FIG. 24 shows the dependence of the reflectivity of a test cell using melamine-nanoparticles, on the angle of incident light in the switched-off- and switched-on-state of the cell,

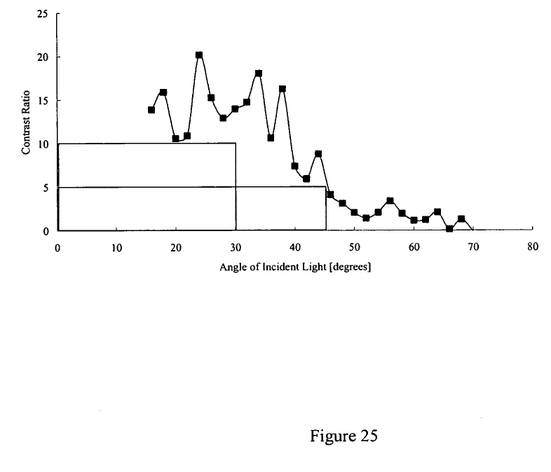

FIG. 25 shows the contrast ratio calculated from the reflectivity data of FIG. 24.

### EXAMPLE 1

### Dispersion Preparation

1-20 wt % TiO₂ solution was prepared by mixing Paste 1 (transparent, containing 10 wt % of 10 nm TiO₂ particles in 1-propanol and water) and of Paste 2 (scattering, containing 5 wt % of 300 nm TiO₂ particles in 1-propanol and water). For example, 4.75 g of Paste 1 and 0.25 g of Paste 2 were mixed in order to achieve 5 wt % Paste 2 TiO₂ solution. To ensure a homogeneous mixing, the solution was stirred for one hour and put into ultrasonic bath for 2 h. Then stirred further for 1 h hour.

TiO₂ Layer Fabrication on Platinum Coated Substrate

The solution was doctor-bladed on platinum (Pt) coated glass substrates in order to make a thin homogeneous film. Then the substrates were put on a hotplate of 450° C. for 30 min to evaporate 1-propanol and water in the film. Of course, the substrate is not limited to Pt coated glass substrates, and the choice of the coating & substrate depends on the application. The substrate can be coated with anything transparent (e.g. ITO, FTO, etc.) to reflective (e.g. Ag, Au, etc.). Also the substrate can be made of anything (e.g. polymer, silicon, steel, TFT, composite, etc).

By using a profilometer, the thickness of the layers varied between 1.7 and 2.7 μm depending on the Paste 2 (FIG. 1). This is thick enough to be used inside a D-SPDLC (dichroic sponge polymer dispersed liquid crystal cell) cell gap size, which is normally 8-15 μm. The thickness of the layer increases with the increase of 300 nm TiO₂ particles, and the layer appears whiter as the layer becomes thicker; the amount of surface scattering increases with the layer thickness.

The reason for utilizing these TiO₂ nano-particles is because using these one can achieve sufficient scattering at such thin layer thickness. Of course, the invention is not limited to nanoparticles made from TiO₂. Furthermore, one can make similar scattering layer with larger particles size such as 1-3 μm, but this would lead to thicker film as the scattering efficiency of such larger particles drops. The ideal particle size is between 100 nm and 800 nm, preferably between 300 nm and 800 nm, which is comparable to the wavelength of the visible light.

### EXAMPLE 2

### Reflectivity Measurement of TiO₂ Coated Pt Substrate

The reflectivity of the TiO₂ coated Pt substrates were measured using an LCD evaluation system “Photal Otsuka Electronics LCD-700”. The detector was set at 0° (surface normal) while the incident parallel white light was moved from 150 to 70°. The normalization of 100% was taken using diffusing White standard (Labsphere SRS 99-020).

The results, FIG. 2, show that the reflectivity profile can be varied by the concentration of TiO₂ Paste 2. Each number corresponds to wt % of the TiO₂ paste. PDLC in the figure represents Polymer Dispersed Liquid Crystal formed on an ordinary back plane (BP) in order to control the scattering by other methods than just TiO₂. However, such a PDLC film tends to be too thick to be used as a back plane. It can be seen that the TiO₂ coated Pt substrates have higher reflectivity above 30 degrees compared to the ordinary back plane. This means that the viewing angle dependence (sudden brightness change with the viewing angle) is suppressed with the TiO₂ coated substrates.

### EXAMPLE 3

### TiO₂ Layer Fabrication on TFT Back Plane

The same TiO₂ solution was doctor-bladed on TFT back plane in order to make the back plane more diffusive. As can be seen from FIG. 3-5, the TiO₂ solution reacts with the TFT back plane at elevated processing temperatures. However, the temperature can be increased without detriment if the TiO₂ concentration is low; in this example, there are no degradation reactions below 1 wt % concentration. Nevertheless, it is desirable to evaporate 1-propanol and water at room temperature in vacuum in this case. TFT back planes shown in FIG. 3-5 have polyimide alignment layers which acts as a blocking layer between the back plane and TiO₂ layer. It is not necessary to have the polyimide layer, but it helps to suppress the degradation reactions, which can be seen at 4 wt % TiO₂ solution dried in vacuum oven at 80 degrees.

FIG. 5 shows that—even at a viewing angle of 45 degrees—the TiO₂ layers dried in vacuum at room temperature stay whiter than the back plane alone. This indicates that, compared to the ordinary back plane, the TFT display made with the modified back plane has less viewing angle dependency on its brightness and contrast ratio. Furthermore, the metal-like specula glare that can be seen on ordinary back plane can be suppressed by the addition of the TiO₂ layer.

The main advantage of the invention is that it allows to modify and/or control the diffusing property of the back plane without having to modify the protuberances themselves. Also, the diffusing layer made by TiO₂ particles is thin enough, so that the influence of the layer to the driving voltage of the liquid crystal cell is minimized.

### EXAMPLE 4

### TiO₂ Back Plane Preparation

In order to obtain a TiO₂ back plane with different degree of scattering property, several layers of TiO₂ were doctor bladed on a TFT back plane with polyimide.

Doctor Blading many Layers

As the number of applied layer increases, the TiO₂ layers start flaking (less attached). This can be observed by eye at 4^{th} layer, but according to FIG. 6, probably it is starting already from the 3^{rd} layer.

TABLE 0-1

| Number | End Thickness [um] | Note |
|---|---|---|
| 1 | 0.7 | |
| 2 | 2.2 | |
| 3 | 7.2 | |
| 4 | 9.2 | Flakes |
| 5 | 10.2 | Flakes |

Doctor Blading Different Height

Using the particle dispersion of example 1, the ideal TiO₂ films were determined to be those with 2-3 μm thickness. However, when using different particle dispersions different thicknesses may prove to be useful. Ideally the thickness of the film is as low as possible, and preferably below 1 μm, for example in the range of from 300 nm to 1 μm.

To obtain more variation in TiO₂ scattering layers, doctor blading different thickness was investigated. The preparation was attempted twice. First with drying in vaccum dessicator (Exp. 1), and second with drying in ambient condition overnight (Exp. 2). As can be seen in FIG. 7, they both showed linear relationship as expected. Exp. 1 gave flakes above 150 μm initial thickness, and Exp. 2 gave flakes above 175 μm initial thickness. In general, Exp. 2 showed more stable TiO₂ which is expected from the slow saturation. At thin final thickness (<1.5 μm), interference of light from the film was observed. Thus the ideal films were determined to be those with 2-3 μm thickness.

### EXAMPLE 5

### Reflectivity of Various TiO₂ Back Planes

Reflectivity profile of TiO₂ layer prepared by different ways were measured. Among those, 2.2 μm TiO₂ layer prepared by drying in vacuum showed the highest value at 30 degree incident light.

TiO₂ Prepared by Drying in Vaccuum

FIG. 8 shows how reflectivity varies with TiO₂ thickness when doctor bladed TiO₂ paste was dried in vaccuum. It can be seen that the reflectivity peaks drops and broadenes with increase in TiO₂ thickness. Among those tested, 2.2 μm thickness showed the highest and broadest reflectivity value at 30 degrees. The 2.21 μm TiO₂ layer was uniform in texture and had no flakes.

TiO₂ Prepared by Drying in Air

FIG. 9 shows how reflectivity varies with TiO₂ thickness when doctor bladed TiO₂ paste was dried in air. It can be seen that the reflectivity peaks drops and broadenes with increase in TiO₂ thickness. Among those tested, 2.7 μm thickness showed the highest and broadest reflectivity value at 30 degrees.

The reason that the reflectivity profile differs from the vacuum-dried ones is probably due to packing of TiO₂ layer. From observation with eyes, air-dried ones are generally more uniform and contains no flakes at higher TiO₂ thickness.

TiO₂ Prepared by Doctor Blading Layers

FIG. 10 shows how reflectivity varies with TiO₂ thickness when TiO₂ layers were doctor bladed on top of each other when dried in vacuum dessicator. It can be seen that the reflectivity peaks drops and broadenes with increase in TiO₂ thickness. Among those tested, 0.7 μm thickness showed the highest and broadest reflectivity value at 30 degrees. However, since the 0.7 μm thick layer produce light interference, the preferred one is 2.2 μm. Flakes could be observed by 7.2 & 9.2 μm layers. This can also be seen by the reflectivity profile by the fact that the peaks from the diffusing back plane were hindered.

Effect of Glass Substrates on Reflectivity

Because the modified back plane will be placed under a test panel, the effect of glass substrates on reflectivity was measured.

As can be seen in FIG. 11, placing 2 glass substrates on each back planes reduce the reflectivity. 3.2 μm TiO₂ layer decreased from 140% to 100%. This results suggests that for the real TFT device (with only one glass substrates), the reflectivity values, and hence contrast ratio, will differ from the test panel values even when the D-SPDLC is the same. The scattering profile is also expected to differ because the scattering of TFT device would be due to TiO₂-LC interface, while the test panel scattering is due to TiO₂-air interface. This experiment is only useful for the test panel demonstration.

TiO₂ Thickness vs. D-SPDLC Reflectivity & Contrast Ratio

TiO₂ thickness effect on D-SPDLC reflectivity and contrast ratio were investigated. Reflectivity (R) values of R=60% and contrast ratio (CR) values of CR=6 could be achieved according to the present invention, in particular with a wide viewing angle and a 2.2 μmTiO₂ layer. These results illustrate the invention's suitability to enhance the performance of reflective displays.

3% B4 79TP-TL203 cell which is a sponge polymer dispersed liquid crystal cell, i.e. a polymer dispersed liquid crystal cell (79 wt. % TL213 LC (liquid crystal) in 21 wt. % PN393 polymer) refilled with a different liquid crystal, in this case doped liquid crystal (3 wt. % B4 (Black-4 dye) doped TL203 LC) was placed on various TiO₂ layers prepared in vacuum (FIGS. 12 and 13), and their reflectivities were measured. As expected, reflectivity peak drops and broadens as the thickness increases.

An approximately 2.2 μm thick layer of TiO₂ particles is favourable in terms of reflectivity, while a layer of approximately 3.2 μm thickness is favoured in terms of broad contrast ratio viewing angle for this particular set up. The precise dimensions may, however, may vary depending on the type and size of particles. In any case the use of a particle film, in particular a nanoparticle film in general on a reflective back plane, as envisaged by the present invention drastically improves reflectivity and contrast ratio values thus opening the door for better display devices.

### EXAMPLE 6

In Example 5, experiments were carried out using two glass substrates within a cell. However, in a real display, the nanoparticle diffuse layer (e.g. the TiO₂ diffuse layer) needs to be placed inside a cell with only one substrate where it is in contact with a pixelated diffuse layer in order to increase the reflectivity and the contrast ratio. This is shown in FIG. 14 wherein a display using two glass substrates and a “real-life display” using only one glass substrate is shown. In the latter, the nanoparticle diffuse layer is in direct contact with a metal diffuse reflector layer. In some instances, the inventors found that a nanoparticle diffuse layer made of TiO₂ nanoparticles which is placed directly on an Ag diffuse reflector undergoes an electrochemical reaction which thus may have detrimental effects on the overall performance of the display, despite the positive characteristics endowed upon the display by the presence of a TiO₂-nanoparticulate layer, in accordance with the present invention.

The inventors thus performed experiments with various nanoparticles other than TiO₂, both in the presence and the absence of an epoxy resin.

a) Various Nanoparticles in the Absence of Epoxy Resin

PMMA (polymethyl methacrylate), melamine, SiO₂ and ZrO₂ nanoparticles were investigated, and ZrO₂ was found to produce the most homogeneous and stable diffusing layer among them. However, the diffuse properties were not as good as with TiO₂.

Measurement Description & Results

The following nanoparticles were investigated.
Techpolymer XX-448Z (PMMA/Polystyrene, 0.4-0.8 um: mean 0.544 um) from Sekisui Plastics.
Epostar S6 (Melamine. 0.25-0.55 um) from Nippon Shokubai.
SiO₂ is from Ubenitto.
Zirconium (IV) oxide (ZrO₂) nanopowder from Aldrich (CAS 1314-23-4) (particle size below 50 nm).

Pastes were made with 10% nanoparticles in 1:1H₂O and IPA isopropanol. Stirred for 30 min, and sonicated for 1 hr. Layers were made by doctor blading a glass bar on Scotch-tape (sella-tape). The resulting layer was heated. ZrO₂ has a melting point of 2700 degrees.
PMMA (Sekisui Plastics, 600 nm) nanoparticles formed a gel by swallowing IPA (isopropanol)
Melamine (Nippon Shokubai, n=1.66, 600 nm, film made was 5 um thick) & ZrO₂ (3 um) nanoparticles gave very white, light & temperature stable layer.
SiO₂ (Ubenitto/Nagase) solution did not adhere well to the diffuse reflector. The resultant film was 14 um.

The various diffuse reflectors are shown in FIG. 15.

A homogeneous paste of ZrO₂ IV (n=2.1) was prepared as follows (paste 1): 3 g ZrO₂, 5 ml H₂O, 0.1 ml Acetyl acetone and 0.05 ml T100 (Triton 100, C₁₄H₂₂O(C₂H₄O)ₙ, where the average number of ethylene oxide units per molecule is around n=9 or 10) were mixed. 3.6 g of the solution and 3 ml of 1-propanol was mixed. The solution was further diluted with an equivalent amount of H₂O and double the amount of 1-propanol.

The reflectivity of a diffuse reflector coated with ZrO₂ nanoparticles was investigated, shown in FIG. 16, wherein 0, 0.5 and 1 means paste 0, 0.5 and paste 1. Paste 0 means a diffuse reflector with ,,no diffuse layer present”; paste 0.5 means a diffuse reflector with a diffuse layer with half of the ZrO₂ concentration of paste 1; and paste 1 means a diffuse reflector with a diffuse layer with paste 1.

Paste 0.5 (dilution of paste 1) was not scattering enough to change diffusion properties. A slight change is observed with “1” which means spin coated once.

Also the number of spin coating steps was varied from 1-5 (the numbers given in FIG. 17 equal the number of spin coated layers on top of each other), which is shown in FIG. 17. In the cells of both FIGS. 16 and 17, the D-SPDLC-layer shown schematically in FIG. 14 has been omitted and reflectivity measurements were performed in its absence.

Increasing the number of spin coating steps widens the diffusing angle. The effect is not as pronounced as with TiO₂.

Furthermore, test cells were made which included a D-SPDLC-layer. The reflectivity of these is shown in FIG. 18, wherein D-SPDLC-test cells were made with ZrO₂ spin coated substrates, employing a number of spin-coating steps. “0.5” denotes a ZrO₂ spin coated substrate using adiffuse layer with half of the ZrO₂ concentration of paste 1; 0, 1, 2, 3 . . . etc. denotes the number of spin coated layers of paste 1 respectively. FIG. 19 shows the contrast ratio of the cell of FIG. 18 in dependence on the incident light angle. The ZrO₂-layers had an average thickness <1 μm.

D-SPDLC test cells were made with ZrO₂ spin coated substrates. In FIG. 18, “2” is inconsistent probably due to an inhomogeneous D-SPDLC. “3 (spin coated three times)” shows the most desirable scattering.

“3” shows the most desirable performance. R=59.6% & CR=5.3. There is scope to improve this even further by optimising the D-SPDLC by using a lift-off method, wherein the D-SPDLC layer is split apart for refilling with a liquid crystal (see also EP-application no. 05003283.8, filed on 16.02.05, incorporated herein by reference).

b) Various Nanoparticles in the Presence of Epoxy Resin

The inventors also constructed various cells, wherein nanoparticles were embedded and/or dispersed in an epoxy resin layer, preferably an epoxy resin layer that was heat-curable or light-curable.

Heat curable epoxy designed to disperse silica nanoparticles (NX7020 from ChemteX, Japan) was used. Melamine (S6 from Nippon Shokubai, Japan) yielded the most homogeneous film, with good reflectivity/contrast properties. Melamine is 1,3,5-triazine-2,4,6-triamine (The melamine particles used had an average size of 250 nm-550 nm.)

The following nanoparticles were investigated.
Techpolymer XX-448Z (PMMA/Polystyrene, 0.4-0.8 um: mean 0.544 um) from Sekisui Plastics.
Epostar S6 (Melamine. 0.25-0.55 um) from Nippon Shokubai.
SiO₂ from Ubenitto.
Zirconium (IV) oxide nanopowder is from Aldrich (CAS 1314-23-4).

10% & 20% of the above nanoparticles were mixed with NX7020 from Nagase ChemteX (NCX), and spin coated on an Ag diffuse reflector.

According to the datasheet of NX7020 heat curable epoxy designed to disperse silica nanoparticles from ChemteX, Japan), the refractive index is 1.64, transmittance is 91%, the solvent used is cyclohexanone C₆H₁₀O₁. Pre-Baking in an oven for 2 min at 100° C., then 30 min at 180° C. The solvent already contains a small amount of catalyst for curing added by the manufacturer. PMMA (Techpolymer) was not compatible with the solvent. Melamine (S6) yielded approximately 1 um layer for 10 wt % loading (left), and 1.5-3.5 um layer for 20% loading (right).

FIGS. 20a-20d shows the results obtained from spin-coating melamine-nanoparticles (FIG. 20a), SiO₂-nanoparticles (FIG. 20b), ZrO₂-particles (FIG. 20c) and no particles (FIG. 20d) within the epoxy resin.

10 wt % Melamine, ZrO₂ and SiO₂ nanoparticle produced a very uniform film. Out of them, the most homogeneous was the film formed with melamine nanoparticles. Melamine (S6) yielded an approximately 1 μm thick layer for 10 wt. % loading (FIG. 20a left), and an approximately 1.5-3.5 μm thick layer for 20 wt. % loading (FIG. 20a right).

SiO₂ yielded an approximately 0.5 um thick layer for 10 wt % loading (left part of FIG. 20b), and an approximately 0.5-1.5 um thick layer for 20 wt. % loading (right part of FIG. 20b). ZrO₂ yielded an approximtely 0.5-1.5 um thick layer for 10 wt % loading (left part of FIG. 20c), and an approximately 2 um thick layer for 20 wt. % loading (right part of FIG. 20b). With no particles, pure NX7020, a 2.5 um thick epoxy layer was produced.

Epoxy Layer Optimisation

The epoxy layer can be optimised in terms of its thickness. In the present case, NX7020 thickness was successfully controlled from 0.1 to 1.2 um by dilution with cyclohexanone. NX7020 was diluted with cyclohexanone at various concentration. It was spin coated at 3000 rpm for 20 s. After the heat polymerisation, the thickness of the resultant layers were measured.

NX7020 thickness was successfully controlled from 0.1 to 1.2 um by dilution with cyclohexanone.

Melamine vs. SiO₂

Melamine nanoparticles showed better results than SiO₂ nanoparticles.

Various concentrations of melamine or SiO₂ nanoparticles in 60% (diluted) NX7020 were made. They were spin coated at 3000 rpm for 20 s. After heat polymerisation, the thickness and roughness of the resultant layers were measured, as shown in FIGS. 22 and 23.

10% melamine in 60% NX7020 resulted in a layer thickness of 0.5 um with a roughness of 1 um. The roughness is still large, but the results show that melamine is smoother and thinner compared with SiO₂. Also melamine yielded more homogeneous films compared with films of SiO₂ nanoparticles.

Reflectivity and Contrast Ratio Measurement with Melamine

D-SPDLCs diffuse layers having melamine nanoparticles showed good reflectivity (66%) and contrast ratio (14:1).

Various LO-SPDLCs (SPDLCs using lift-off method) were made using the following conditions:
20 mW/cm2 Hamamatsu spot light source
79TP (79 wt. % TL 203 LC in 21 wt. % PN 393 UV curable polymer) solution in plasma treated ITO coated glass substrates (EHC, Japan) and fluorinated glass substrates for LO (=lift off); Lift off, referred to in this example and previous examples, was performed as described in Masutani et al. ,,Improvement of Dichroic Polymer Dispersed Liquid Crystal (PDLC) Performance for Flexible Display using lift-off technique”, IDW/Asia Display '05 Proceedings (2005.12, Takamatsu, Japan) and in EP-application no. 05003283.8, filed on 16.02.05, both of which are incorporated herein by reference.
Refilled with 2-4% B4 doped TL203 denoted as B4 is a dichroic dye from Mitsubishi Chemical, and TL 203 is a nematic crystal from Merck)
Cut PI precoated TFT substrate as cover substrate (PI=polyimide)
10% NX7020 with 0-3% S6 melamine were used as diffuse layer on the cut TFT substrate

It was found that cut TFT substrates can be activated/switched if their pixel lines are connected using silver paint. ±40V was used to switch the test cells because many of them switches only half of the pixel lines. By applying exceedingly large voltage e.g. such as ±80V, the whole ITO-pixel overlapped area can be switched.

FIG. 24 shows the angle dependent reflectivity of the best test cell made. 3% melamine diffusing layer and 4% B4 (black dichroic dye) is used for the cell. It can be seen that the reflectivity at 30 degrees is 66% at on-state and 4.8% at off-state.

FIG. 25 shows the contrast ratio calculated from the reflectivity data of FIG. 24. It can be seen that the contrast ratio is 14 at 30 degrees and 5 at 45 degrees.

The data points are not as smooth as possible because only a small (3 mm×3 mm) area was used for the measurement. The small spot size was used because of the inhomogenuity observed in many test cells. A small difference in R_{off} affects the contrast ratio. The data may be expected to be even further improved with more homogenous nanoparticulate diffusing layers which will enable measurements over larger areas.

The features of the present invention disclosed in the specification, the claims and/or in the accompanying drawings, may, both separately, and in any combination thereof, be material for realizing the invention in various forms thereof.

1. A method of controlling light diffusion and/or reducing glare from a surface, in particular a back plane in a display, comprising the steps:
a) providing a surface,
b) preparing a dispersion of particles having an average diameter in the range of from about 1 nm to about 10 μm, preferably a dispersion of nanoparticles,
c) applying said dispersion onto said surface,
thus creating a particle film, preferably a nanoparticle film on said surface.

2. The method according to claim 1, characterized in that it comprises the additional step:
d) drying said dispersion on said surface and/or curing said dispersion, preferably by heat or UV.

3. The method according to claim 1, characterized in that said particles are nanoparticles having an average diameter in the range of from 1 nm to 10 μm preferably 5 nm to 900 nm, more preferably 10 nm to 500 nm, most preferably 10 nm to 300 nm.

4. The method according to claim 1, characterized in that said dispersion of particles, preferably of nanoparticles contains one, two or more types of particles, each type being characterized by an average diameter, with different types of particles having different average diameters.

5. The method according to claim 4, characterized in that said dispersion contains a first type of nanoparticles having an average diameter of 10 nm and a second type of nanoparticles having an average diameter of 300 nm.

6. The method according to claim 1, characterized in that said particle film, preferably said nanoparticle film has a thickness of 0.2 μm to 5 μm, preferably 0.3 μm to 4 μm, more preferably 0.5 μm to 3 μm, even more preferably 0.5 μm to 2 μm, most preferably 0.5 μm to 1 μm.

7. The method according to claim 1, characterized in that said dispersion of particles, preferably of nanoparticles has a concentration of particles, preferably nanoparticles of 1-50 wt. %, preferably 1-40 wt. %.

8. The method according to claim 1, characterized in that said particles, preferably said nanoparticles are made of a material selected from the group comprising TiO₂, SiO₂, CeO₂, Al₂O₃, MnO₂, Fe₂O₃, ZrO₂, PMMA and melamine.

9. The method according to claim 1, characterized in that said dispersion of particles, preferably nanoparticles contain at least one solvent which does not dissolve said particles, and/or a UV or heat curable polymer.

10. The method according to claim 9, characterized in that said solvent is selected from the group comprising water, ethanol, 1-propanol, isopropanol, butanol, toluene, dichloromethane, THF, 2-propanol, methanol, acetone, DMF and DMSO and mixtures thereof.

11. The method according to claim 1, characterized in that said applying occurs by a process selected from doctor blading, drop casting, spin casting, Langmuir-Blodgett-techniques, sol-gel, spin coating, dip-coating, spray coating.

12. The method according to claim 1, characterized in that said dispersion of particles is applied onto said surface together with a resin, preferably an epoxy resin, that may be curable by heat or light.

13. The method according to claim 12, characterized in that said resin, upon application onto said surface, forms a layer having a thickness in the range of from 0.1 μm to 2 μm, preferably 0.5 μm to 1.5 μm, more preferably 0.5 μm to 1.2 μm.

14. The method according to claim 1, characterized in that said surface is a reflective surface, in particular a reflective back plane in a display, or it is a transparent surface, in particular a transparent back plane in a display.

15. The method according to claim 14, characterized in that said surface further has an additional layer on top of it facilitating said particle film, preferably said nanoparticle film adhering to said surface or protecting said surface from reacting with said particle film, preferably said nanoparticle film.

16. The method according to claim 15, characterized in that said additional layer is made of a material selected from the group comprising polyimide, SiO₂, LiF, MgO, Al₂O₃, Si₃N₄.

17. The method according to claim 1, characterized in that said drying and/or said curing occurs in vacuum or in air under ambient conditions.

18. The method according to claim 1, characterized in that said surface is made of a material, selected from the group comprising glass, polymers, silicon, steel, a composite material.

19. The method according to claim 18, characterized in that said surface is coated with a transparent material, for example indium tin oxide (ITO), fluorine-doped tin oxide (FTO), SnO₂, ZnO, Zn₂SnO₄, ZnSnO₃, CdSnO₄, TiN, Ag, or with a reflective material, for example a metal, such as silver, gold, platinum.

20. The method according to claim 2, characterized in that steps c) and d) are repeated, preferably several times, thus creating a particle film, preferably a nanoparticle film comprising at least two, preferably several layers of particles, preferably nanoparticles.

21. The method according to claim 1 characterized in that steps a) and b) are performed in the order ab or ba.

22. A particle film on a surface produced by the method according to claim 1.

23. A display comprising a back plane having a particle film, preferably a nanoparticle film on top of it, produced by the method according to claim 1.

24. Use of a particle film, preferably of a nanoparticle film, according to claim 22, for controlling light diffusion and glare from a surface.
